(19) United States
(12) Patent Application Publication
(10) Pub. No.: US 2020/0171432 A1
(43) Pub. Date: Jun. 4, 2020

(54) A FILTERING APPARATUS AND METHOD FOR TREATING POLLUTED AIR IN INDOOR SPACES

(71) Applicants: UNIVERSIDAD DE LOS ANDES, Santiago (CL); PONTIFICIA UNIVERSIDAD CATÓLICA DE VALPARAÍSO, Valparaíso (CL)

(72) Inventors: Alberto Octavio VERGARA FERNANDEZ, Santiago (CL); Patricio Alejandro MORENO CASAS, Santiago (CL); German Eduardo AROCA ARCAYA, Valparaíso (CL)

(73) Assignees: UNIVERSIDAD DE LOS ANDES, Santiago (CL); PONTIFICIA UNIVERSIDAD CATÓLICA DE VALPARAÍSO, Valparaíso (CL)

(21) Appl. No.: 16/617,834

(22) PCT Filed: May 28, 2018
(86) PCT No.: PCT/IB2018/053784

§ 371 Date: Nov. 27, 2019

Related U.S. Application Data
(60) Provisional application No. 62/512,402, filed on May 30, 2017.

(51) Int. Cl. B01D 53/85; B01D 53/18; B01D 53/04; F24F 3/16

(52) U.S. Cl. CPC B01D 53/85; F24F 2003/1657; B01D 53/0431; F24F 3/16; B01D 2251/95; B01D 2257/302; B01D 2257/404; B01D 2257/502; B01D 2257/504; B01D 2257/7027; B01D 2257/708; B01D 2257/91; B01D 2259/4508; F24F 2003/1617; B01D 53/18

(57) ABSTRACT

The invention relates to a filtering apparatus and method for treating polluted indoor air, which can be operated by gas scrubbers, adsorbers, or through the use of a microbial biodegrading medium for polluting gases, wherein said apparatus allows the biofiltration method to be efficient and applicable in indoor spaces. The technical problem of the efficiency of the filter has to do with said filter being able to process the greatest amount of pollutants during a minimum residence time and with a filter bed volume that allows the application thereof in apparatus that have an adequate size for indoor spaces, such as spaces inside the household, i.e., allowing the reactor to operate at maximum capacity without having to increase the size thereof.

The present invention relates to the field of purification treatments for polluted air in confined spaces, such as spaces inside the household; specifically, this invention relates to a filtering apparatus and method with biological and physical-chemical action for purification of polluted air in confined spaces.

### DESCRIPTION OF THE PRIOR ART

Currently, most countries in the world have serious air quality problems, mainly due to aerosols and toxic substances. It is important to reduce air pollution because it has undesirable effects on human health. The long-term effects of air pollution on health include chronic respiratory diseases, lung cancer, heart disease, possible brain damage, neurological disorders, and damage to the liver and kidneys, as well as other unwanted health effects. According to the World Health Organization, 2.4 million people die each year from diseases directly related to air pollution.

Polycyclic aromatic hydrocarbons (PAHs) are one of the most prominent groups of toxic air pollutants. They originate mainly from the incomplete combustion of organic material, such as biomass burning and the combustion of fossil fuels, largely residing in fine airborne particles that enter deeply into the human lungs.

In most places, PAH pollution is not only induced by the use of fossil fuels in automobiles and residential wood burning but also by industrial activity, which has become the main source of air toxics, both in gas and solid phase, significantly decreasing the quality of urban air in open spaces as well as inside buildings (homes, public buildings, shopping malls, etc.). This is aggravated by the self-inflicted pollution generated inside these constructions, for example, the volatile organic compounds (VOCs) that can be found in paints, solvents, glues, etc.

Indoor air pollution is a complex problem that must consider particles (such as dust and smoke from biomass combustion), biological agents (molds and spores), and different types of pollutants in general, such as CO, CO₂, NOx, SOx, aldehydes, formaldehyde, toluene, benzopyrene, other VOCs, particulate matter bacteria, fungal spores and other pollutants. These last pollutants are suspected to be responsible for the major cause of decreased Indoor Air Quality associated with health problems and the so-called “Sick Building Syndrome”, added to the effect of pollutants, such as benzopyrene, generated by the combustion of biomass for heating.

As can be deduced, there is an established and also quantified problem related to indoor air pollution and its different effects on human health, which does not have a solution in its origin in the short and medium term, for multiple technical, political, economic and cultural reasons. This establishes an opportunity for implementing types of recognized environmentally friendly biological technologies, providing a specific and quick solution to a problem that is directly affecting the health of people.

Existing solutions for the treatment of indoor air pollution include a wide variety of systems or combinations of systems, which depend on the types of pollutants and the sources of pollution. Furthermore, it is believed that many air pollutants have not yet been discovered and, therefore, a treatment approach may be necessary that ensures maintaining indoor air pollutants, such as pollutants produced by the combustion of biomass and fossil fuels, above satisfactory levels at all times.

Natural aeration is without a doubt the easiest and most economical alternative for reducing indoor pollution but this is often desirable during cold weather due to low temperatures and/or external pollution conditions. Natural aeration is also impossible in tall buildings mainly due to safety problems, climate control or noise.

In the worst-case scenario (without heat recovery), the energy requirements for maintaining a 100 m² commercial office, with a room height of 2.5 m, at 23° C., and having ventilation with outside air (approx. 4° C.), considering an air exchange rate of 3 times the volume of the room per hour, would be approximately 3420 kWh/month, which indicates the difficulty of purifying the air by considering ventilation. This is aggravated by the fact that outdoor air is often more polluted than indoor air.

Current methods for indoor air purification include combinations of air filtration, ionization, adsorption with activated carbon, ozonization and photocatalysis. These systems can be integrated into the central ventilation system or used as portable air purifiers (or air filters), which are designed for limited spaces. These particle removal strategies are fairly well developed and may include combinations of filtration and electrostatic precipitation. However, this is very different when it comes to the elimination of gaseous compounds such as VOCs (like formaldehyde) and benzopyrene.

Many tests and developments have been carried out for indoor air purification, especially aimed at removing gaseous compounds such a VOCs, among others. The assessed technologies include adsorption, ultraviolet photocatalytic oxidation (UVPCO), ozone oxidation, air ionization and a botanical purifier, wherein the latter type was able to remove around 20% of formaldehyde. However, these botanical systems have low efficiency and it may be because an air exchange rate of three volumes of rooms per hour is generally recommended for indoor air treatment, which means that large amounts of air must be treated in relatively small units (for the proper use of indoor space without visual or acoustic disturbance). This may be difficult to achieve in botanical purifiers where air is vented in the soil through the roots of plants.

In botanical purifying systems such as the one developed in U.S. Pat. No. 6,676,091, the air is forced directly through vertical (or slightly inclined) porous material that serves as a support for hydroponic plants, the main objective of which is to support the activity of the microorganisms in order to degrade the pollutants in the rhizosphere. It seems that the role of plants in botanical purifiers often consist in supporting the microbial activity responsible for the removal of pollutants. However, it is known that during phytoremediation of contaminated soils the accumulation of direct pollutants or their degradation occurs in plants, therefore, the capacity of plants in botanical purifiers to directly remove pollutants during air treatment is under debate.

A recent study has suggested that the bacteria growing on the leaves of plants can also contribute to the biodegradation of VOCs. In general terms, there is growing evidence of the complexity and importance of the interactions between plants and microorganisms and therefore, research in this area is of utmost importance in order to improve indoor air quality, basically considering that the biological treatment of organic compounds is based on the capacity of microorganisms to use these molecules as sources of carbon, nutrients and/or energy.

Apparatus have been developed to apply these biological or biofiltration methods, some of which can be seen in patents such as U.S. Pat. No. 9,534,800 (Kruglick) published on Mar. 1, 2007, which describes a biofilter that includes an organic medium for the growth of plants and one or more colonies of microorganisms, and also DE19602792 (HUBERT BLOCK) published on Oct. 9, 1998, which describes an apparatus that acts as a biological filter of circulating air; it is a bed with plants which is made of activated carbon.

In this area, we can mention that mainly there are two types of biofilters for treating VOC gases: conventional biofilters and the so-called trickling biofilters. Conventional biofilters comprise a bed of biofilter medium (a layer of a biologically active support medium) a layer of gravel, and a multiple duct distribution pipeline. The bed of the biofilter medium is packed with a biologically active medium such as soil, peat, sawdust or straw, where microorganisms attached to this medium are capable of degrading pollutants and the waste gas is purified when it passes through the layer of medium. The bed of biofilter medium has several advantages such as short residence times, high removal efficiency; it is a simple device with low investment and operation costs. However, it has disadvantages such as uneven air distribution and unstable performance over a long operating life. The special difficulties associated with this process are bed clogging, increased pressure drop and deterioration in removal caused by the high degree of clogging when the conventional biofilter has been operating for a long time.

Trickling biofilters also known as drip filter beds use inert raw materials for the filling medium such as crushed stones, plastic particles, ceramic and carbon fibers, wherein the circulating nutrient solution is sprayed from top to bottom in order to the biofilm growth on the surface of the filling medium. The biofilm had adsorption and bio-degradation capacities so that gaseous pollutants are transferred to the biofilm and degraded. In general, it is necessary to regularly supply the nutrients necessary for microorganisms to maintain stable elimination efficiency over the long term. Compared to the conventional biofilter, the reaction conditions of the trickling biofilter are easy to control, the concentration of microorganisms is high per unit of volume of bed medium, the waste gas does not have to be moistened. The trickling biofilter has several disadvantages such as the clogging of the resulting medium due to the excessive accumulation of microorganisms in the bed medium, a greater drop in pressure caused by the generation of conduit flows and the consequent decrease in yield due to the excess accumulation of biomass when the filter is operated especially under high load over a long period of time.

Most of the currently existing problems with biofiltration apparatus are that, considering their use in confined interior spaces and not for industrial use, they are not compact structures, made up of external deposits and pipes that reach the deposit of the biofilter bed; they have difficulties in capturing the surrounding polluted air since most of them use a collector duct that introduces the air through a single point or through a single upper or lower face, directing the air axially towards and inside the bed, decreasing the ability to capture air in a homogeneous way and thus creating dead areas without air capture, which ultimately result in an inefficient process that requires oversizing the filter bed in order to ensure a desired performance.

Many of these apparatus lack a good capacity to spread the polluted air homogeneously inside the apparatus, such that there is generally a higher concentration of pollutants in the area surrounding the inlet duct and a lower concentration in remote areas.

On the other hand, most of the existing solutions based on apparatus with an inner biofilter bed have mechanical means of blowing or suctioning in order to generate turbulence and forced ventilation of the flow, which prevents regulating the residence time of the pollutants in the bed, because, in general, they are made up of a single tank wherein the polluted air enters through a single duct or wall and goes directly to the bed, without any intermediate barriers that force or control the in-dwelling of the gases, thus becoming inefficient.

Meanwhile, there are air-purifying devices for industrial applications, which use biofiltration devices for air purification. In these applications, the air that is to be treated contains high concentrations of polluting elements, and the discharge of the polluted air is carried out through a duct or discharge stack of the industrial process.

An example of this type of reactors is described in US 2006/027099 A1, which shows a configuration in which the purification device is connected to a discharge duct or stack of an industrial process, such that the polluted air enters the device axially at a central point thereof and passes through the biofilter by means of a radial flow inside the reactor, in order to interact with the biofilter material and exit the reactor as purified air.

Document US 2006/027099 A1 shows a traditional rotating bioreactor technology traditionally used in water treatment and which can be applied to the treatment of air. In this type of technology, air intake is axial and through a single central pipe, so the distribution of air inside the device and the time for the treatment thereof is not homogeneous, which decreases the overall efficiency of the system. This is due to the fact that technologies for industrial applications are not useful for toxic substances in low concentrations, but rather they operate when there are high concentrations, where the aim is not generating a homogeneous distribution of the fluid throughout the biofilter, nor controlling the residence time thereof.

However, for non-industrial applications, such as indoor purification, whether inside homes, shopping malls or other applications, different air conditions must be considered, it being confined air, the toxic substances of which are lipophilic and are furthermore found in low concentrations. These working conditions make the technologies for industrial applications inefficient, since they require a device that is efficient in environments with low concentrations of polluting elements, and where the intake of air into the device is not carried out through the discharge of a pipe from an industrial process, but the air to be treated is uniformly distributed throughout the entire environment. Consequently, there is a need in the state of the art for a device that can ensure efficient air treatment in residential environments with low concentrations of polluting elements that is capable of optimizing residence time and homogeneous distribution of the air inside the device.

### DESCRIPTION OF THE INVENTION

The invention relates to a filtering apparatus and method for treating polluted indoor air, which can be operated by gas scrubbers, adsorbers, or through the use of a microbial biodegrading medium for polluting gases, wherein said apparatus allows the biofiltration method to be efficient and applicable in indoor spaces.

The technical problem of the efficiency of the filter has to do with said filter being able to process the greatest amount of pollutants during a minimum residence time and with a filter bed volume that allows the application thereof in apparatus that have an adequate size for indoor spaces, such as spaces inside the household, i.e., allowing the reactor to operate at maximum capacity without having to increase the size thereof.

In order to resolve this problem, the present invention is based on the combined achievement of the following objectives:

increasing the capture of surrounding polluted air,

spreading the polluted air homogeneously from the intake to the outlet of the apparatus as purified air,

allowing greater control of the residence time of the polluted air in the apparatus,

allowing balanced nutrition and moistening, in case a biofilter medium is used, in order to improve the solubilization of the pollutant and thus the degradation thereof.

In view of the foregoing, the present invention provides an apparatus for domestic use or for use in indoor spaces that enables carrying out an efficient method for the purification of polluted air found in said indoor space, wherein said apparatus is compact and enables use in small spaces without having to carry out large-scale installations or arranging exit ducts through the walls of the room. The means of purification includes the preferred use of a medium with biological support, or the use of adsorbent and/or gas scrubbing means, but not limited to the use of one of these options in particular.

This compact apparatus basically consists of a reactor comprising a container with a permeable wall that houses a filter medium, two additional tanks, each of which are arranged axially with respect to the longitudinal axis of the reactor and means for the optimized diffusion of the polluted gaseous fluids towards the reactor and the diffusion of liquids between the tanks and the reactor.

The apparatus of the present invention provides efficient means for capturing the surrounding air, which is achieved by increasing the collection surface through an array of perforations that can be found in the outer walls of the reactor and through the arrangement of a mechanical air extracting device that generates a suction force from the central core of the apparatus, causing the polluted air to be attracted and drawn into the apparatus in a 360° radial direction, and at full height, to be then conveyed towards the reactor and towards a central column for the evacuation of the filtered air, connected to said extracting device.

The apparatus also provides optimized means for diffusing air and moisture flows inside the apparatus, wherein said means comprise and outer cover arranged concentrically on the outer side of the reactor that generates an interstice between both elements, which acts as a pre-chamber; in this pre-chamber, the incoming air is subjected to flow mixing that homogenizes the concentration of pollutants before entering the reactor and wherein it also generates a homogenization of pressure drop that forces the air in this pre-chamber in order to diffuse it also homogeneously in the upper, middle and lower areas of said reactor.

The turbulence and homogenization of pressure drop in the pre-chamber is generated by the upward income of a current of steam generated in the lower tank, thanks to the fact that it contains a moisturizing fluid and an ultrasonic membrane device that generates steam at low temperatures from high frequency vibrations by raising and separating water in the form of steam.

This steam is transferred to the pre-chamber by means of a set of perforations aligned along the perimeter on a plate that separates said outer cover from the lower tank, such that as the steam rises, it mixes with the incoming air, which enables conditioning the incoming air by homogenizing the concentration of pollutants, optimizing the transfer rate in the biodegradation process, since the filter bed receives the same concentration throughout the volume thereof.

This mixture of rising steam with the incoming air also forces it to ascend through the pre-chamber, such that, in addition to having a homogeneous mixture, this conditioning in the pre-chamber enables that the distribution of incoming air in the reactor is also homogeneous in the upper, medium and lower areas.

The mentioned lower plate also comprises another group of central perforations, which enable the passage of residual decanting fluid from the reactor to said lower tank and recirculation thereof as steam.

The apparatus further provides means for regulating the residence time of the polluted air with the aim of taking full advantage of the capacity of the biodegradable bed in the reactor, without having to have large volumes of this bed to ensure the processing of all the pollutant.

These means are derived from a dimensional and spatial relationship between a series of perforations found both in the outer cover that generates the pre-chamber, and in the reactor and the central evacuation column, together with the volume of said pre-chamber, the reactor and the central evacuation column; wherein this dimensional and spatial relationship of components and the perforations ensures that the polluted fluid that has entered the pre-chamber does not pass rapidly from the exterior towards the reactor and subsequently to the evacuation column, which would render the concentration of pollutants not homogeneous and thus would make it enter the reactor also in a non-homogeneous manner, reducing the possibility of the filter working at maximum capacity, since certain areas would become saturated and exhausted before other areas where the same concentration of pollutants did not penetrate. Thus, the idea is that the relationship between the perforations and the contained volumes allows an adequate advance of the air giving time to the biofilter bed to execute the degradation of the pollutants, without accumulating and clogging the system.

Therefore, it is proposed that the air intake area generated by the sum of the area of the larger perforations found in the outer cover be greater than the area of air intake to the reactor generated by the sum of the intermediate perforations of said reactor, whereby the diameter of said larger perforations corresponds between 3 to 5 times the diameter of the intermediate perforations, preferably to 5 times the diameter of the intermediate perforations and where the area of the larger perforations corresponds to 30% of the entire surface of the mantle of said outer cover; in turn, the width of the pre-chamber, i.e., the separation between the inner face of the outer cover and the outer face of the reactor, is equivalent to between 7 to 10% of the inner diameter of the outer cover, preferably is equivalent to 9% of the inner diameter of the outer cover. Thus, greater pressure is achieved in this pre-chamber, generated by the confinement of the fluid in contact with the rising steam coming from the lower tank, which causes the turbulence necessary for homogenizing the concentration of pollutants in said incoming air, such that the former remains in the pre-chamber long enough to be homogenized before passing on to the reactor. Similarly, this steam is also a moisturizing agent of the biofilter medium.

The in-dwelling period of the polluted air is also a result of the dimensional relationship between the perforations of the central evacuation column and the perforations of the reactor, these being smaller in diameter, equivalent to between 60 to 75% of the diameter of the intermediate perforations of the reactor, preferably is equivalent to 75% of the diameter of the intermediate perforations of the reactor; while the ratio of the diameter/volume of the reactor corresponds to 18% of the ratio of the outer diameter/volume of the central column.

The invention also provides means for supplying the nutrient fluid to the biofilter medium inside the reactor, which optimizes the solubilization of the volatile pollutant and therefore the degradation thereof, avoiding high moisturization, since excess moisture in the biofilter medium generates saturation and lowers pressure, hence diminishing solubility. Thus, these means for supplying nutrient fluid comprise the upper tank axially arranged on the reactor, containing the nutrient fluid, which, by means of a set of sprayers, supplies the fluid in the upper part of the reactor.

The apparatus proposed herein enables carrying out the optimized method for biofiltration of polluted air in indoor spaces, wherein said method is based on the use of a microbial biodegrading medium for polluting gases, comprising the following steps:

drawing the polluted air into the apparatus by using a mechanical extracting device located in the upper central part of the apparatus,

introducing the polluted air radially and all along the height of the mantle of the outer cover of the apparatus through the larger perforations thereof towards the pre-chamber,

generating steam in the lower tank with the action of the ultrasonic membrane device,

directing the steam towards the pre-chamber through the perimeter perforations of the lower plate,

maintaining the incoming air in the pre-chamber and subjecting it to flow mixing when combined with the rising steam in order to homogenize the concentration of pollutants,

introducing the homogenized incoming air towards the biofilter medium found in the reactor by means of the intermediate perforations found in the mantle of said reactor,

supplying the nutrient fluid to the biofilter medium by passing the nutrient fluid contained in the upper tank towards the upper area of the reactor by means of sprayers,

moisturizing the biofilter medium intermittently by means of steam from the lower tank,

allowing the residence time of the polluted air in the biofilter medium in order to produce the biodegradation of the pollutants,

radially transferring the polluted air in the process of biodegradation from the outer area of the reactor towards the area of the longitudinal core thereof.

passing the resulting filtered air towards the central extraction column through the smaller perforations found in the mantle of said column,

directing the purified air through the central column upwards through an exit duct and driven by the mechanical extracting device,

allowing the purified air to flow out of the apparatus in order to diffuse it into the surrounding environment and enabling it to be recirculated again in the apparatus.

### DESCRIPTION OF THE DRAWINGS

A detailed description of the invention will be carried out in combination with the drawings that are part of this presentation, wherein:

FIG. 1 shows a view of a longitudinal section of the entire filtering apparatus, wherein arrows can be seen indicating the direction of the incoming and outgoing air flow.

FIG. 2 shows a view of a longitudinal section of the apparatus.

FIG. 3 shows a view of a cross section of the apparatus, wherein arrows can be seen indicating the direction of the incoming and outgoing air flow.

FIG. 4 shows a view of a longitudinal section of the apparatus, wherein arrows can be seen indicating the direction of the incoming and outgoing air flow.

FIG. 5 shows a detailed and enlarged view of the upper area of the apparatus.

FIG. 6 shows a detailed and enlarged view of the lower area of the apparatus.

FIG. 7 shows a plan view of the lower plate of the apparatus.

FIG. 8 shows a bottom isometric view of the upper plate of the apparatus with part of the upper tank.

FIG. 9 shows an isometric view of the outer cover.

FIG. 10 shows an isometric view of the reactor with the central evacuation column.

FIG. 11 shows an isometric view of the entire apparatus.

FIG. 12 shows the relative frequency at the taxonomic level of the genus of bacteria (FIG. 12a) and fungi (FIG. 12b) detected in the sample. They are only represented that there are levels that are present in more than 1%.

### DETAILED DESCRIPTION OF THE PREFERRED EMBODIMENT

The present invention relates to a filtering apparatus (1) and a method for the treatment of polluted air in indoor spaces that preferably operates with, but is not limited to, a biofilter medium (A) for polluting gases, which is carried out through the mentioned apparatus, enabling the optimization of the filtering method.

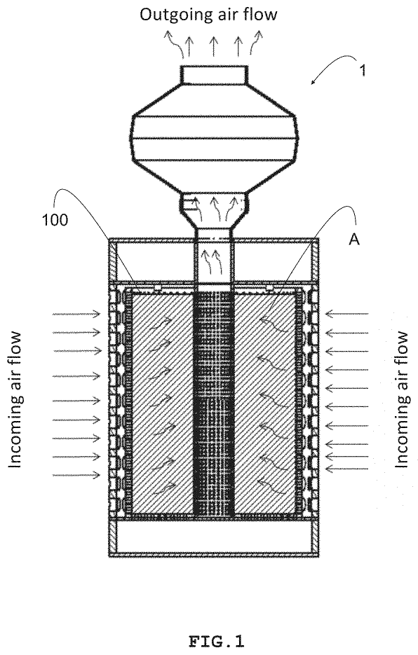

An exemplary embodiment of the present invention is shown in FIG. 1, wherein the apparatus comprises a reactor (100) that houses a microbial biofilter medium (A) and a series of external and internal elements that surround it in order to achieve the intake of polluted air into the system, passing it through the biofilter medium, degrading the pollutants and evacuating the resulting purified air from the system. However, as it will become apparent to a person skilled in the art, the present invention is not limited to the use of a microbial biofilter medium, it can also be carried out by using different types of filtering devices, either through biological support means, adsorbent and/or gas scrubbing means, thus not being limited to any of these means in particular.

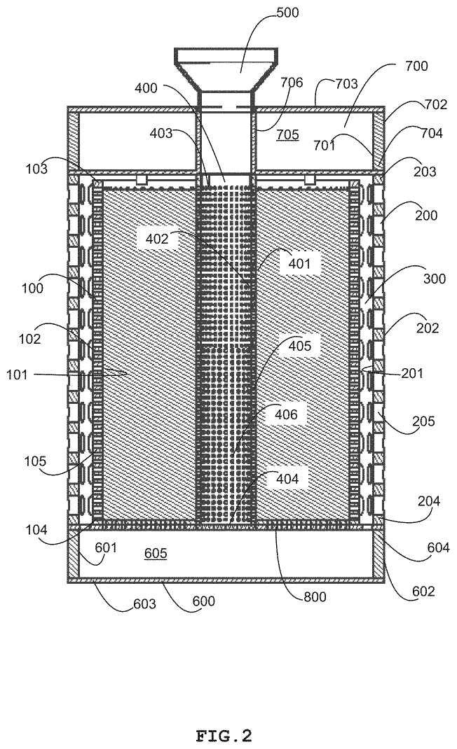

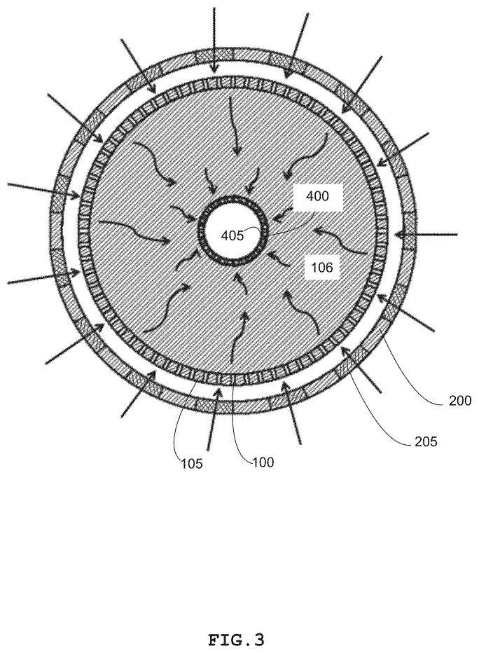

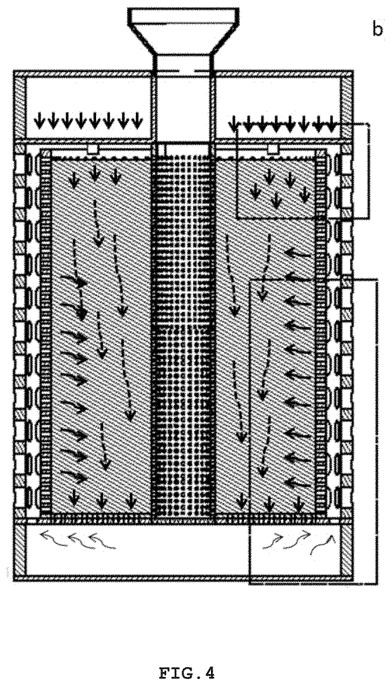

As best seen in FIG. 2 and FIG. 3, the apparatus includes an outer cover (200) arranged concentrically on the outside and radially distanced from the reactor (100), which comprises a laminar mantle defined by an inner face (201), and an outer face (202), an upper edge (203) and a lower edge (204), wherein said mantle is provided with a plurality of larger perforations (205) organized and distributed all along the height and the perimeter of said mantle.

The sum of the area of the larger perforations (205) found in the outer cover (200) is greater than the sum of the area of the intermediate perforations (105) of said reactor (100). On the other hand, the diameter of said larger perforations (205) corresponds between 3 to 5 times the diameter of the intermediate perforations, preferably to 5 times the diameter of the intermediate perforations (105) of the reactor; while the sum of the area of the larger perforations (205) corresponds to 30% of the entire surface of the outer face (202) of the outer cover (200).

As can be seen in FIG. 2 and FIG. 3, the reactor (100) comprises a laminar mantle defined by an inner face (101), an outer face (102), an upper edge (103) and a lower edge (104) defining an internal cavity (106), while the mantle thereof comprises a plurality of intermediate perforations (105) organized and distributed all along the height and the perimeter of said mantle.

As best seen in FIG. 6, the apparatus also comprises a pre-chamber (300) located between the reactor (100) and the outer cover (200), which consists of a hollow separating space between the outer face (102) of the reactor and the inner face (201) of the outer cover (200), said separation being equivalent to 9% of the inner diameter of said outer cover.

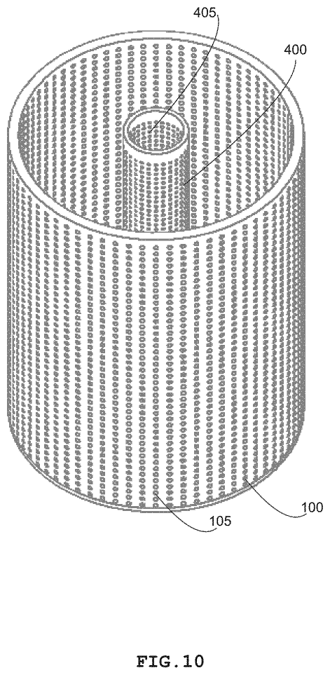

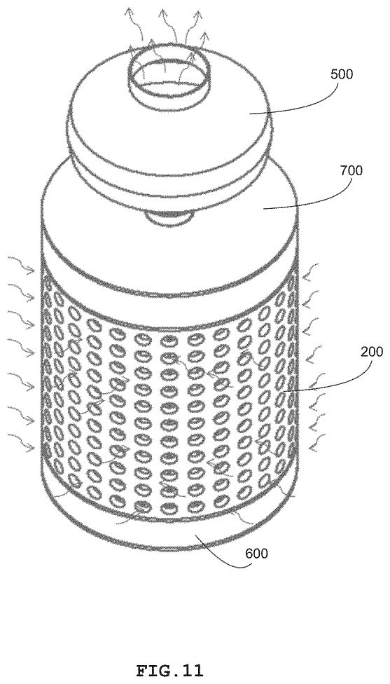

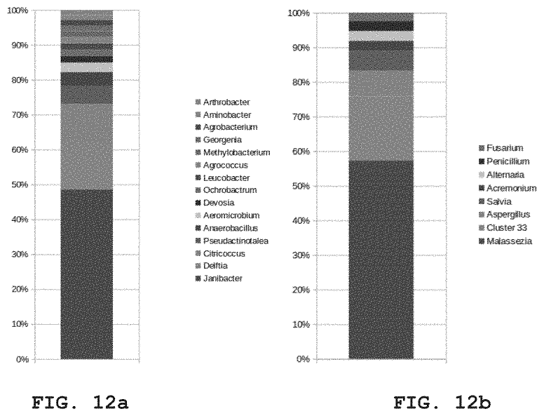

As seen in FIG. 2 and FIG. 10, a central evacuation column (400) is arranged inside and at the top of the reactor (100), which is linked in its upper part to a mechanical extractor (500) that generates suction and enables triggering the process through the movement of gaseous fluids.

This central evacuation column (400) is a hollow cylindrical body defined by an outer face (401), an inner face (402), an upper edge (403) and a lower face (404) defining an internal cavity (406), wherein the body is provided with a plurality of smaller perforations (405) organized and distributed all along the height and the perimeter of said mantle.

The plurality of smaller perforations (405) found in said central column (400) are distributed all along the height and the perimeter of the mantle thereof, these being of smaller diameter than the diameter of the intermediate perforations (105) of the reactor, corresponding to (75%) of the diameter of the intermediate perforations (105).

On the other hand, the diameter/volume ratio of the reactor (100) corresponds to 18% of the outer diameter/volume ratio of the central column (400).

With reference to FIG. 2, the invention further comprises a lower tank (600), axially arranged under the outer cover (200), for containing moisturizing fluid comprising an ultrasonic membrane device for generating steam (not shown).

The lower tank (600) comprises a laminar mantle defined by an inner face (601), an outer face (602), a lower face (603) and an upper edge (604) defining an internal cavity (605).

In turn, the apparatus includes an upper tank (700), as seen in FIG. 2, arranged axially on the outer cover (200), for containing nutrient fluid from the biofilter medium in the reactor, wherein said tank comprises a laminar mantle defined by an inner face (701), an outer face (702), an upper face (703) and a lower edge (704) defining an internal cavity (705), in the center of which a hollow cylinder (706) is arranged parallel to the mantle.

The apparatus has a lower plate (800), which as seen in FIG. 2, is axially arranged between the outer cover (200) and the lower tank (600), which comprises means of transfer between the lower tank (600) and the pre-chamber (300), and means of transfer between the lower tank (600) and the reactor (100).

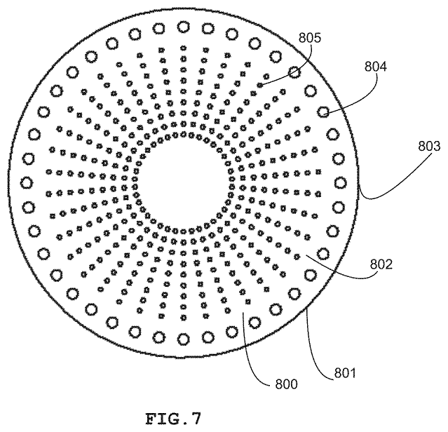

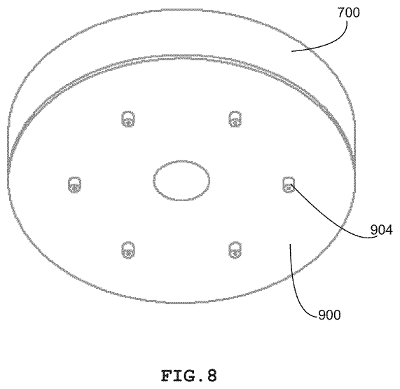

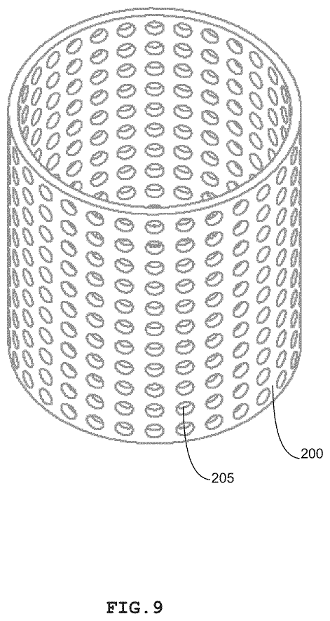

As best seen in FIG. 7, the lower plate comprises a perimeter edge (801), an upper face (802) and a lower face (803), while the means of transfer between the lower tank (600) and the pre-chamber (300) correspond to a plurality of perimeter perforations (804) distributed equidistantly in a circular line parallel to the perimeter edge (801) and the diameter of which is equivalent to 50% of the diameter of the larger perforations (205) of the outer cover (200).

On the other hand, the means of transfer between the lower tank (600) and the reactor (100) correspond to a plurality of perforations (805) radially arranged in the central area of the plate (800) and the diameter of which equals 40% of the diameter of the perimeter perforations (804).

As seen in FIG. 2, the perimeter edge (801) of the lower plate (800) also coincides in shape and diameter with the lower edge (204) of the outer cover (200) and with the upper edge (604) of the lower tank (600).

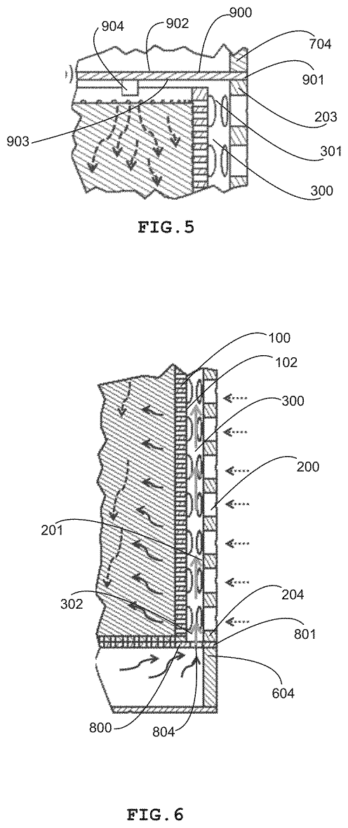

As seen in FIG. 2 and FIG. 5, the apparatus further incorporates an upper plate (900), axially arranged between the outer cover (200) and the upper tank (700), comprising spraying means (904) that transfer the nutrient fluid from the upper tank (700) towards the upper part of the reactor (100).

This upper plate (900) comprises a perimeter edge (901), an upper face (902) and a lower face (903), wherein said perimeter edge (901) coincides in shape and diameter with the upper edge (203) of the outer cover (200) and with the lower edge (704) of the upper tank (700).

As seen in FIG. 5, the pre-chamber (300) comprises an upper perimeter end (301) and a lower perimeter end (302), and is arranged perpendicularly to the lower plate (800) coinciding with a plurality of perimeter perforations (804).

Additionally, the apparatus includes means for controlling and monitoring the humidity and the temperature levels found in the filter (not shown), while the perforations of the outer cover (200), those of the reactor (100) and those of the central column (400) may be in the shape of a circle, square, rectangle or any other regular geometric shape.

In the configurations in which a biofilter medium is used, the content of the inner tank (100) comprises a microbial consortium and an inorganic medium designed to biologically degrade pollutants from the incoming air.

The biofiltering o filtering method for treating polluted air in indoor spaces that operates with a biofilter medium (A) for polluting gases and which is carried out with the apparatus described above, comprises the following steps:

drawing the polluted air into the apparatus (1) by using a mechanical extracting device (500) located in the upper central part of the apparatus,

introducing the polluted air radially and all along the height of the mantle of the outer cover (200) of the apparatus through the larger perforations (205) thereof towards the pre-chamber (300),

generating steam in the lower tank (600) with the action of the ultrasonic membrane device,

directing the steam towards the pre-chamber (300) through the perimeter perforations (804) of the lower plate (800),

maintaining the incoming air in the pre-chamber and subjecting it to flow mixing when combined with the rising steam in order to homogenize the concentration of pollutants,

introducing the already homogenized incoming air towards the biofilter medium (A) found in the reactor (100) by means of the intermediate perforations (105) found in the mantle of said reactor,

supplying the nutrient fluid to the biofilter medium (A) by passing the nutrient fluid contained in the upper tank (700) towards the upper area of the reactor by means of sprayers (904) found in the upper plate (900),

moisturizing the biofilter medium (A) intermittently by means of the steam from the lower tank (600),

allowing the residence time of the polluted air in the biofilter medium (A) in order to produce the biodegradation of the pollutants,

radially transferring the polluted air in the process of biodegradation from the outer area of the reactor towards the area of the core thereof,

passing the resulting filtered air towards the central extraction column (400) through the smaller perforations (405) found in the mantle of said column,

directing the purified air through the central column (400) upwards through an exit duct, driven by the mechanical extracting device (500),

allowing the purified air to flow out of the apparatus (1) in order to diffuse it into the surrounding environment and enabling it to be recirculated again in the apparatus.

### EXAMPLES

Biodegradation capacity of the biopurifier in an indoor environment contaminated was simulated inside of hermetic chamber.

Biopurifier prototype was based on a cylindrical structure of polyvinilclorure (PVC) of 52 cm height, conformed by three cylindrical sections with different diameter (30.2, 27.3 and 5.19 cm). All the cylindrical sections have holes that allow that sucks the air to a range of 360° taking advantage of the available surface of the biopurifier. The pollution air enters through the outer cover to then pass through the intermediate cover which contains vermiculite that packing material, where the degradation by microbial activity is carried.

Once the biopurifier was assembled, the inoculation of the biopurifier support was done adding 16 L of vermiculite that porous support, 2 L of mineral medium with a concentration of 22 g L−1 of fungus Fusarium solani CSB 117476 and 2 L of nutrient solution with 9.9 g L−1 of Rhodococcus erythropolis DSM 43066 bacteria. Moisture of the solid support was maintained over 65% through top feeding of culture medium by sprinklers. In addition, a humidifying device Mist Maker (Neptune Hydroponics) located in the lower part of the biopurifier generates steam from the remaining culture medium that subsequently was transported through the separation of the biofilter section and the external cover.

The flow rate of polluted air to the biopurifier was greater than 13.5 L min−1.

The moisture of chamber air inside was measured with a digital psychrometer.

Operational parameters for all toluene, formaldehyde and BaP removal experiments were expressed in terms of elimination capacity (EC, g m−3 h−1), inlet load (IL, g m−3 h−1) and removal efficiency (RE, %).

### Example 1

The contaminated air was continuously fed to the hermetic chamber during 25 days, gradually increasing the input concentration of toluene and formaldehyde from 1 to 2 g m−3; 1 to 4 g m−3, respectively. While BaP remained under 10 g m−3. The start-up was performed maintaining a chamber temperature at 21° C. The flows rate fed to the hermetic chamber were 0.1 L min−1, 0.2 L min−1 and 0.5 L min−1 of BaP, toluene and formaldehyde, respectively.

During the startup period, the first 9 days the inlets concentrations of contaminants were variable inside the chamber.

After of 9 days, concentrations of toluene, formaldehyde and BaP were maintained around 1.2±0.03, 1.97±0.5 and 7.67±2. g·m−3, respectively. In this time, the microorganisms had grown and attached enough to the packing material, achieving removal efficiencies greater than 70% for toluene and Bap; and 96% for formaldehyde.

Subsequently, formaldehyde obtained efficiencies removal of 98%. Toluene showed efficiencies of 90% from day 11, reaching a 98% on day 22. In the case of BaP, the first 10 days of startup the removal efficiency was over 70% reaching a maximum value of 91% on day 23.

Regarding the degradation rates were progressively increasing until reaching maximum values on day 17 of startup. The degradation rates achieved for toluene, formaldehyde and Bap were 0.63, 5 and 4.6 g·h−1, respectively.

### Example 2

The inlet concentrations in the hermetic chamber were set between 2.74 to 4.55 g m−3 for toluene and in the range of 0.8 to 4.37 g m−3 for formaldehyde. BaP inlet concentrations of 15.71 to 25.61 g m−3 were applied. In addition, a temperature of 21° C. and an empty bed residence time (EBRT) of 5.8 s were maintained.

The biopurifier was run in four batch feeding on distinct periods that comprised one cycle of 210 h followed by cycle of 280 h, both with an inlet load of toluene, formaldehyde and Bap of 2.9, 0.9 and 16 g·m−3, respectively. Additionally, two cycles of 415 h and 1380 h of operation were performed increasing toluene, formaldehyde and Bap concentrations to 4.0, 4.0 and 20.0 g·m−3, respectively, RE obtained in the first and second cycles, were 99% for toluene and 95% for BaP, values that kept constant when inlets concentrations of these gases were increased in third and fourth cycles. In the case of formaldehyde, when the inlet concentration was increased to values higher than 4 g·m−3, RE always improved in the consecutive batch until reached values of 80%.

On the other hand, EC of toluene (0.02 g·m−3·h−1) and Bap (0.09 g·m−3·h−1) were maintained even after one-month operation. While with formaldehyde EC obtained were between 0.002-0.006 g·m−3·h−1. This results demonstrated that the microorganisms maintained their degradative activity independently of inlet concentrations of the pollutants during large time operations.

### Example 3

An experiment in continuous fed lasting for 2 months was carried out at the following conditions: temperature 21° C., EBRT of 5.8 s and inlet concentrations of toluene, formaldehyde and BaP about 5.7, 4.5 and 4.3 g m−3, respectively.

Under the above operating conditions the average ER of toluene and BaP within the 10 days were higher than 90%, reaching EF of 99% and 95%, respectively in the steady state, which is similar efficiencies obtained in batch operation (second stage of experiments), but with a concentration higher in 97% for toluene and 73% lower in the case of BaP. Furthermore, the average ER for 4.5 g·m−3 of formaldehyde increased 10% in comparison to reached in transient conditions (80%) with a concentration of only 0.9 g·m−3. During this phase the biopurifier showed enhancement not only in the biopurifier performance represented in the removal efficiency but as well decreased the fluctuation of the inlet and effluent concentration.

### Example 4

After long-term operation with continuous gaseous feed, the mixture pollutants stopped feeding on three occasions: 2, 5, and 15 days. During these starvation periods, the data of toluene, formaldehyde and BaP concentrations confirmed that biomass was able to degraded significant the pollutants inside the reactor. After of each starvation period, the pollutants feed was re-started under the same conditions as prior to the interruption (5.5 g·m−3 for toluene and 4.5 g·m−3 for formaldehyde and BaP).

The results obtained indicate that the biopurifier without feed for 2 and 5 days, elimination capacities of toluene (0.11 g·m−3·h−1), formaldehyde (0.08 g·m−3·h−1) and Bap (0.07 g·m−3·h−1), were similar to that observed previously in the initial feeding stage at identical operational conditions, indicating the absence of re-acclamation period. However, the biopurifier with starvation for 15 days, EC between the initial feeding stage and subsequent re-acclamation, decreased in 20% for Bap and 35% for toluene and formaldehyde. This indicates that longer periods of starvation required periods of re-acclimation, but that the system was able to recover in all cases. In the case of the experience with 15 days feed stoppage, required 29 h more, in comparison with the 2 and 5 days of starvation that needed 46 h for be re-established the biodegradation rates. Besides, the final concentrations reached by not feeding carbon source for 15 days, were higher in 23% for Bap, 50% for formaldehyde and 276% for toluene, compared to the other two experiences.

On the other hand, the results prove that the fungal-bacteria species could withstand more than 2 weeks starvation and remain active, being necessary to maintain the support moisture by adding mineral medium.

Through this experiment demonstrates that by using an inorganic support, with clean air supply and moisture control, the environmental conditions and nutrients were enough to assure the fungal-bacteria population survival for 15-days without pollutants feed as carbon source.

### Example 5

Fan suction speed studied were 10, 100 and 250 m³ h⁻¹. Inlet concentrations of toluene, formaldehyde and BaP about 5.7, 4.5 and 4.3 g·m⁻³, respectively. In the case of toluene in all fan speed, concentration of this compound decreased quickly to the background level after the fan was turned on. Independently the airflow rate, toluene was completely biodegraded in the first 6 hours. The elimination capacity was 0.9 g·m⁻³·h⁻¹ in all cases.

In the three fan speeds, formaldehyde was consumed in 89% at 24 h and remained concentration maintained in the time at inside chamber. However, with higher airflow rate passing by the biopurifier formaldehyde concentration decreased faster that traduced into an increase of 27% in the EC to change de fan speed from 10 m³·h⁻¹ until 100 m³·h⁻¹. At 250 m³·h⁻¹ of suction speed was not observed increased in the elimination capacity.

Similar trend to obtained in formaldehyde was observed for BaP, respect to the effect of airflow rate. BaP concentration decreased faster at change from 10 m3·h−1 until 100 m³·h⁻¹ of suction speed. Results also indicated that the EC at fan speeds of 100 and 250 m³·h−1 were same (0.47 g·m⁻³·⁻¹), but higher in 24% than that at 10 m³·h⁻¹.

The increase in the suction speed in the fan caused a failure in the moisture control in the biopurifier; moisture content decreased to values lower than 50%, being able to promoting channeling and affecting the microbial activity. The restoration of the moisture content to values around 60-80% led to ER of 99% for toluene, 90% for formaldehyde and 86% for BaP.

### Example 6

The structure and composition of the bacterial and fungal communities in the biopurifier were evaluated in samples of the packing material after 8 months of continuous operation of the device.

To establish the possible contamination by bacteria and fungi from the interior of the biopurifier to the controlled environment, plates with potato dextrose agar were placed in different places of the hermetic chamber. These plates were taken every day and cultivated to observe the presence of colonies growth.

The study consisted in the analysis of samples obtained at the end of the operation of the biopurifier, in order to discern the populations of bacteria and fungi that are in it. For this, a strategy was approached by capturing hypervariable regions of the rRNA, V3-V4 of the 16S gene in bacteria; and of the capture of the hypervariable regions of the ITS in fungi. All the samples were grated in duplicate. DNA extraction was carried out from the homogenization of the samples using the isolation protocol of the ‘DNeasyMericon kit’ from Qiagen. The resulting samples were measured by means of nanodrop with a result of DNA quality and concentration within the optimal ratios (concentration ng μl−1 293.1, A260/280 1.73 and A260/320 1.16).

Libraries were prepared for both the 16s and the ITS, and the final concentration measured in Picogreen of the libraries built were 14.85 ng μl−1 for 16S and 15.4 ng μl−1 for ITS.

The samples were loaded on the MiSeq platform of Illumina and sequenced in a combination of 300 nts Paired End. Each of the groups of sequences was compared against a database of 16S rRNA in the case of bacteria and ITS in the case of fungi, using the BLAST strategy of local alignment to associate each group with one of the taxonomic groups of the database.

The genera of microorganisms detected in the filter are indicated in FIG. 12. The main bacterial genus corresponds to Janibacter, followed by Delfia and Citricoccus. As for the fungi, the most represented genus corresponds to Malassezia, followed by Aspergillus and Salvia.

This shows a filtering potential of the biopurifier, with the capacity to retain bacteria and fungal spores present in the environment, since the studies of plate cultures presented in the chamber did not show growth of fungal and bacterial colonies.

1. Filtering apparatus for the treatment of polluted air in indoor spaces, comprising:
a reactor consisting of a permeable wall container and housing a filter medium,
an outer cover that surrounds the reactor and is arranged axially with respect to the longitudinal axis thereof, radially distanced from it,
a central evacuation column arranged in the center of the apparatus and adjacent to the reactor, connected in the upper part thereof to a means of suction,
a lower tank, arranged under the outer cover, containing moisturizing fluid,
a lower plate between the outer cover and the lower tank, comprising means for transferring a moisturizing fluid between the lower tank and a pre-chamber, and means of transfer for transferring the moisturizing fluid between the lower tank and the reactor,
wherein the pre-chamber is formed between the reactor and the outer cover, and allows mixing the incoming flow of polluted air with the moisturizing fluid, causing the formation of turbulence that homogenizes the concentration before entering the reactor, and
wherein the outer cover, the reactor and the central column comprise a plurality of perforations having different dimensional and spatial relationships, which allow controlling the in-dwelling period of the fluid inside the apparatus.

2. The filtering apparatus according to claim 1, wherein the apparatus allows filtering different types of air pollutants such as CO, CO₂, NOx, SOx, aldehydes, formaldehyde, toluene, benzopyrene, other VOCs (volatile organic compounds), particulate matter, bacteria, fungal spores and other pollutants.

3. The filtering apparatus according to claim 2, wherein the bacteria and fungal spores correspond to Janibacter, Delfia, Citricoccus, Malassezia, Aspergillus and Salvia.

4. The filtering apparatus according to claim 1, wherein the lower tank comprises an ultrasonic membrane device for generating steam.

5. The filtering apparatus according to claim 1, wherein the filter medium can operate by means of gas scrubbers, absorbers or by using a microbial biodegrading medium for polluting gases.

6. The filtering apparatus according to claim 5 wherein it further comprises an upper tank, axially arranged on the outer cover, for containing a nutrient fluid of the microbial biodegrading medium in the reactor.

7. The filtering apparatus according to claim 6, further comprising an upper plate, arranged between the outer cover and the upper tank, comprising spraying means for transferring the nutrient fluid to the reactor.

8. The filtering apparatus according to claim 1, wherein the outer cover, the reactor and the central column correspond to cylindrical bodies, of the same height, and are organized in a concentric manner.

9. The filtering apparatus according to claim 1, wherein the reactor comprises a laminar mantle defined by an inner face and an outer face, wherein the plurality of perforations are of intermediate size and are organized and distributed all along the height and the perimeter of said mantle; wherein the sum of the area of the larger perforations of the outer cover is greater than the sum of the area of the intermediate perforations of the reactor; and wherein the diameter of said larger perforations of the outer cover corresponds between 3 to 5 times the diameter of the intermediate perforations of the reactor.

10. The filtering apparatus according to claim 1, wherein the outer cover comprises a laminar mantle defined by an inner face and an outer face, wherein the plurality of perforations are of larger size and are organized and distributed all along the height and the perimeter of said mantle; wherein the sum of the area of the larger perforations of the outer cover is greater than the sum of the area of the intermediate perforations of the reactor; and wherein the diameter of said larger perforations of the outer cover corresponds between 3 to 5 times the diameter of the intermediate perforations of the reactor.

11. (canceled)

12. (canceled)

13. The filtering apparatus according to claim 10, wherein the diameter of said larger perforations of the outer cover corresponds to 5 times the diameter of the intermediate perforations of the reactor.

14. The filtering apparatus according to claim 10, wherein the sum of the area of the larger perforations corresponds to 30% of the entire surface of the outer face of the outer cover.

15. The filtering apparatus according to claim 1, wherein the pre-chamber consists of a hollow separating space between the outer face of the reactor and the inner face of the outer cover, said separation being equivalent to between 7 to 10% of the inner diameter of said outer cover.

16. The filtering apparatus according to claim 15, wherein the pre-chamber consists of a hollow separating space between the outer face of the reactor and the inner face of the outer cover, said separation being equivalent to 9% of the inner diameter of said outer cover.

17. The filtering apparatus according to claim 1, wherein the central column is a hollow cylindrical body, wherein the plurality of perforations are of a smaller size and are organized and distributed all along the height and the perimeter of the cylindrical body.

18. The filtering apparatus according to claim 17, wherein the plurality of smaller perforations are smaller in diameter than the diameter of the intermediate perforations of the reactor, corresponding to between 60 to 75% of the diameter of the intermediate perforations.

19. The filtering apparatus according to claim 18, wherein the plurality of smaller perforations are smaller in diameter than the diameter of the intermediate perforations of the reactor, corresponding to 75% of the diameter of the intermediate perforations

20. The filtering apparatus according to claim 17, wherein the ratio of the diameter/volume of the reactor corresponds to 18% of the ratio of the outer diameter/volume of the central column.

21. The filtering apparatus according to claim 1, wherein the lower tank comprises a laminar mantle defined by an inner face, and outer face, a lower face and an upper edge defining an internal cavity.

22. The filtering apparatus according to claim 6, wherein the upper tank comprises a laminar mantle defined by an inner face, and outer face, an upper face and a lower edge defining an internal cavity.

23. The filtering apparatus according to claim 1, wherein the means of transfer between the lower tank and the pre-chamber correspond to a plurality of perimeter perforations distributed equidistantly in a circular line parallel to the perimeter edge and the diameter of which is equivalent to between 30% to 50% of the diameter of the larger perforations of the outer cover.

24. The filtering apparatus according to claim 23, wherein the means of transfer between the lower tank and the pre-chamber correspond to a plurality of perimeter perforations distributed equidistantly in a circular line parallel to the perimeter edge and the diameter of which is equivalent to 50% of the diameter of the larger perforations of the outer cover.

25. The filtering apparatus according to claim 1, wherein the means of transfer between the lower tank and the reactor correspond to a plurality of perforations radially arranged in the central area of the lower plate and the diameter of which equals to 40% of the diameter of the perimeter perforations.

26. The filtering apparatus according to claim 25, wherein the perimeter edge of the lower plate coincides in shape and diameter with the lower edge of the outer cover and with the upper edge of the lower tank.

27. The filtering apparatus according to claim 7, wherein the upper plate comprises a perimeter edge that coincides in shape and diameter with the upper edge of the outer cover and with the lower edge of the upper tank.

28. The filtering apparatus according to claim 1, further comprising means for controlling and monitoring the humidity and temperature levels found in the filter.

29. The filtering apparatus according to claim 1, wherein the perforations of the outer cover, those of the reactor and those of the central column may be in the shape of a circle, square, rectangle or any regular geometric shape.

30. The filtering apparatus according to claim 5, wherein the microbial biodegrading medium for polluting gases contained in an inner tank comprises a microbial consortium and an inorganic medium designed to biologically degrade the pollutants from the incoming air.

31. A filtering method for treating polluted air in indoor spaces according to claim 1, comprising the following steps:
drawing the polluted air into the apparatus by using a mechanical extracting device located in the upper central part of the apparatus,
sucking the polluted air radially and all along the height of the mantle of the outer cover of the apparatus through the larger perforations thereof towards the pre-chamber,
generating steam in the lower tank,
directing the steam towards the pre-chamber through the perimeter perforations of the lower plate, generating flow mixing when combining with the polluted air in order to homogenize the concentration of pollutants,
introducing the polluted air into the filter medium in the reactor through the intermediate perforations of the reactor,
allowing the residence time of the polluted air in the filter medium so that filtering of the pollutants takes place,
passing the resulting filtered air towards the central extraction column through the smaller perforations of said column,
directing the purified air axially through the central column through an exit duct, driven by the mechanical extracting device,
allowing the purified air to flow out of the apparatus in order to diffuse it into the surrounding environment.

32. The filtering method according to claim 31, wherein when a biofilter medium is used, the method further comprises the step of supplying nutrient fluid to the biofilter medium, passing the nutrient fluid contained in the upper tank to the upper area of the reactor by means of sprayers found in the upper plate.

33. The filtering method according to claim 31, further comprising intermittently moisturizing the biofilter medium by means of the steam from the lower tank.
